(19) United States
(12) Patent Application Publication
(10) Pub. No.: US 2017/0177072 A1
(43) Pub. Date: Jun. 22, 2017

(54) APPARATUS AND METHOD FOR ACTUATING A HAND SUPPORT FOR AN INPUT DEVICE, HAND SUPPORT FOR AN INPUT DEVICE, INPUT SYSTEM FOR A TECHNICAL DEVICE, AND METHOD FOR PRODUCING A HAND SUPPORT FOR AN INPUT DEVICE

(71) Applicant: Cherry GmbH, Auerbach/Opf (DE)

(72) Inventor: Tolga AKCADAG, Bayreuth (DE)

(73) Assignee: Cherry GmbH, Auerbach/Opf (DE)

(21) Appl. No.: 15/321,049

(22) PCT Filed: Jun. 9, 2015
(86) PCT No.: PCT/EP2015/062796

§ 371 Date: Dec. 21, 2016

(30) Foreign Application Priority Data
Jul. 3, 2014 (DE) 10 2014 212 916.8

(51) Int. Cl. G06F 3/01; G10L 21/06; G08B 6/00; G06F 3/16

(52) U.S. Cl. CPC G06F 3/01; G06F 3/16; G10L 21/06; G08B 6/00

(57) ABSTRACT

An apparatus for actuating a hand support for an input device, in particular a keyboard, of a technical device is presented. The apparatus comprises an input interface for receiving an audio signal and a signal processing device coupled to the input interface and configured to provide an actuation signal using audio data transmitted via the audio signal, wherein the actuation signal is configured to actuate the hand support in a manner characterizing the audio signal.

### BACKGROUND

1. Technical Field

The present invention relates to an apparatus and a method for actuating a hand support for an input device, to a hand support for an input device, to an input system for a technical device, and to a method for producing a hand support for an input device.

2. Background Information

Input devices of technical devices, such as computers, provide so-called force feed-back to a user of the technical device for specific applications. By means of the force feedback, relevant information on the input device may be communicated to the user in a haptically perceptible manner via the input device. Computer games are a popular field of application of force feedback, for example. There, the player may be given mechanical feedback regarding occurrences in the game by the input device vibrating when vehicles collide or weapons are fired, for example. A situational increase of the resistance to motion of the input device in certain directions is also possible. Predetermined vibration or motion patterns for various gaming situations often are available so as to give an impression of a current gaming situation which is as realistic as possible. For example, in a racing game, a vehicle colliding with a wall may produce a short, sudden jerk in the input device. When a vehicle in the game is driving along a drawn-out turn, a constant centering force may act on the input device. Furthermore, the input device may be made to constantly vibrate during firing of a fully automatic weapon in a first person shooter.

In this context, US 2011 0309212 A1 discloses an orthopedic wrist rest. Accessories and extensions may be reversibly attached to the wrist rest, to provide heat, vibration, or structural aspects such as light, fan or ionizer.

### BRIEF SUMMARY

Against this background, the present invention provides an improved apparatus for actuating a hand support for an input device, an improved method for actuating a hand support for an input device, an improved hand support for an input device, an improved input system for a technical device, and an improved production method for producing a hand support for an input device in accordance with the main claims. Advantageous embodiments are defined in the subordinate claims and the following description.

A hand support for an input device of a technical device comprises an apparatus having an input interface for receiving an audio signal and a signal processing device, wherein the signal processing device is configured to determine and actuation signal for actuating the hand support. By means of the input interface and the signal processing device, an actuatable hand support may be provided as a discrete application.

An apparatus for actuating a hand support for an input device, in particular a key-board, of a technical device comprises: an input interface for receiving an audio signal; and a signal processing device coupled to the input interface and configured to provide an actuation signal using audio data transmitted via the audio signal, wherein the actuation signal is configured to actuate the hand support in a manner characterising the audio signal.

The technical device may, for example, be a computer. The hand support may be an elongated, flat element which may be arranged adjoining the input device so that a user of the technical device may place or rest their hand or hands, in particular the heels of the hands, on the hand support when manipulating the input device, so as to guard against too much strain on the hands or wrist joints when working with the technical device. In case the input device is a computer keyboard, the user may, for example, may place the heels of their hands or their wrist joints on the hand support and does not need to actively support their weight. In this sense, the hand support may also be referred to as a heel support or wrist rest. The audio signal may, for example, characterise an action of the user one the input device, e.g., a keystroke, or a content of a program the user currently is working on. Actuating in a manner characterising the audio signal may be understood so as to mean that, by elements arranged in or on the hand support, the hand support is set to motion which a user of the technical device may perceive haptically via their hands resting on the hand support.

An apparatus may be a technical device processing electrical signals, for example sensor signals, and outputting control signals depending thereon. The apparatus may comprise one or more suitable interfaces, which may be configured as hardware and/or software. If configured as hardware, the interfaces may, for example, be part of an integrated circuit implementing functions of the apparatus. The interfaces may also be discrete integrated circuits or at least partly consist of discrete components. If configured as software, the interfaces may be software modules on a microcontroller along with other software modules, for example.

According to one embodiment of the apparatus, input interface may comprise a connector, in particular of a USB interface. This makes the apparatus universally applicable, and the signal data of the audio signal may be read into the apparatus in a particularly manner.

According to another embodiment, the signal processing device may comprise a storage device for storing reference audio data and may be configured to provide the actuation signal using the reference audio data. The storage device may, for example, be an EEPROM. A plurality of different reference audio data may be filed in the storage device, wherein predefined actuation signals may be associated with predefined reference audio data. Selection of an actuation signal to be provided may be done in the signal processing device by means of a comparison of the received audio data with the reference audio data. Here, reference audio data most closely corresponding to or most closely resembling the audio data received via the audio signal may be selected as the audio data determining the actuation signal. The comparison and the selection of the suitable reference audio data may be done by means of a microcontroller which may be comprised by the signal processing device and which may be configured to access the storage device.

Furthermore, the apparatus may comprise an actuating device which may be coupled to the signal processing device. The actuating device may be configured to effect, in response to the actuation signal, actuation in a manner haptically perceptible for a user of the technical device who manipulates the input device. In particular, actuation may be affected in a manner adjacent to the hands or heels of the hands of the user, when they are working with their hands on the technical device using the input device. This embodiment of the apparatus offers the advantage that information represented by the actuation signal can be received quickly and intuitively by the user, without the user's current work with the computer being compromised.

In particular, the haptically perceptible manner of actuation may be a vibration of at least a portion of the hand support. In this way, the information contained in the actuation signal may advantageously be communicated to the user in a particularly pleasant, yet impressive manner. The user's concentration on their work with the technical device will hardly be affected or will not be affected at all.

According to a further embodiment, the actuating device may comprise a signal amplifier for amplifying the actuation signal and at least one actuator coupled to the signal amplifier. The actuator may be configured to perform the actuation in response to an actuation signal amplified by the signal amplifier. For example, the actuating means may comprise two actuators which may be arranged at different positions in or on the hand support, e.g., each at a position in the vicinity of which a user's hand will probably be when working with the technical device. For example, the actuator may be a small electric motor. Using the signal amplifier, electric currents in the signal processing device arranged upstream with respect to the actuating device may advantageously be kept small. Thus, both the energy consumption and the constructed space may be kept as small as possible.

A hand support for an input device, in particular a keyboard, of a technical device comprises an apparatus in accordance with one of the embodiments previously mentioned and a housing, wherein at least the signal processing device of the apparatus is arranged inside the housing.

The housing may be of elongated shape and of a width corresponding to a width of the input device and may be suited to be positioned on a desk surface or similar surface between the input device and the user adjacent to the input device, so that the user may comfortably rest their hands or heels of their hands on the housing when working with the input device, without a functionality of the apparatus being limited thereby. The apparatus, which forms the electronic section of the hand support, may be arranged in a concentrated or distributed manner the housing.

According to an embodiment of the hand support, the housing may at least partially be formed of elastically deformable plastics. Using soft and resilient plastic material for the housing, may guard particularly well against signs of fatigue of the user's hands or wrist joints. Furthermore, the haptic actuation may thus be effected in an efficient, yet low-noise manner.

For example, the housing may comprise at least one elastically deformable pad on one outer face. The pad may be coupled to the at least one actuator, in particular. The at least one pad may be arranged on a bottom side of the housing supposed to be facing a surface for the hand support or on a top side of the housing supposed to be facing the hands of the user. If arranged on the bottom side, the pad may easily and effectively prevent slipping of the hand support which might be caused by the actuation. Arrangement on the top side, particularly if the actuator is positioned directly on the pad, may have the positive effect that actuation of the actuator may be forwarded, in a particularly effective manner, to the outside of the housing where the hands of the user are. In particular, this applies if the pad or pads, along with the actuator or actuators, are positioned where the hand or hands of the user normally rest on the hand support or rests when working with the technical device.

According to an embodiment of the hand support, the connector may be integrated in a wall of the housing. The connector may be formed to accommodate a further connector pluggable together with the connector for electrically connecting the apparatus to the input device. In this embodiment, the connector may be formed so that the further connector can be plugged into the connector, in particular. This embodiment of the connector has the advantage that contacts of the connector are protected from damage particularly well. Moreover, in this embodiment, the hand support is of particularly compact build.

According to an alternative embodiment of the hand support, the input interface comprises a connecting cable guided out of the housing. Correspondingly, the connector may be arranged at a free end of the connecting cable. In this embodiment, the hand support is already provided with an integrated connection for electrically linking the hand support to the input device. Inadvertent loss or misplacement of the cable for electrically connecting device and hand support may be precluded.

Furthermore, the hand support may be designed so that the housing comprises at least one snap-fit for attaching the hand support to the input device. Thus, the hand support may attached to and again removed from the input device quickly and easily without using tools and with little manual force. The hand support may thus also be employed with different technical devices in an uncomplicated manner and according to what is desired and needed by the user.

An input system for a technical device comprises an input device, in particular a key-board, and a hand support according to one of the embodiments previously described, wherein the input device and the hand support are integrally formed or the hand support is removably attachable or attached to the input device via at least one snap-fit.

If integrally formed, the input device and the hand support may comprise a common housing, which may be formed of different materials, however. The input device may comprise a rigid housing, which may be rigidly connected to the elastically deformable housing of the hand support.

A method for actuating a hand support for an input device, in particular a keyboard, of a technical device comprises steps of: receiving an audio signal via an input interface; and providing and actuation signal using audio data transmitted via the audio signal by means of a signal processing device coupled to the input interface, to actuate the hand support in a manner characterising the audio signal.

By executing the method, a hand support presented herein may be actuated, e.g. made to vibrate, such that information of a program run on the technical device by a user can be communicated to the user of the technical device in an emphatic and intuitive way.

A production method for producing a hand support for an input device, in particular a keyboard, of a technical device, comprises steps of: providing an apparatus for actuating the hand support, wherein the apparatus comprises an input interface for receiving an audio signal and a signal processing device coupled to the input interface and configured to provide an actuation signal using audio data transmitted via the audio signal, wherein the actuation signal is configured to actuate the hand support in a manner characterising the audio signal; providing a housing for the hand support; and combining the apparatus with the housing to produce the hand support.

The production method may be executed in a fully or partially automated manufacturing environment for producing a multiplicity of previously presented hand supports.

What is also advantageous is a computer program product with program code which may be stored on a machine-readable carrier, such as a semiconductor memory, a hard-drive memory or an optical memory, and is used for executing the method in accordance with one of the embodiments previously described, when the program is executed on a computer or an apparatus.

### BRIEF DESCRIPTION OF THE DRAWINGS

The invention will be explained in greater detail by way of example using the appended drawings, in which:

FIG. 1 shows a principle illustration of a technical device with an input system according to an embodiment of the present invention;

FIG. 2 shows a block diagram of an apparatus for actuating a hand support for an input device according to an embodiment of the present invention;

FIG. 3 shows a perspective view of a hand support for an input device according to an embodiment of the present invention;

FIG. 4 shows a perspective view of a portion of a hand support for an input device according to a further embodiment of the present invention;

FIG. 5 shows a schematic illustration of a hand support for an input device with identification of a mounting location of an apparatus for actuating the hand support according to an embodiment of the present invention;

FIG. 6 shows a perspective view of an apparatus for actuating a hand support for an input device, which apparatus is integrated in the hand support, according to an embodiment of the present invention;

FIG. 7 shows a flowchart of a method for actuating a hand support for an input device according to an embodiment of the present invention; and

FIG. 8 shows a flowchart of a production method for producing a hand support for an input device according to an embodiment of the present invention.

### DETAILED DESCRIPTION OF THE DRAWINGS AND THE PRESENTLY PREFERRED EMBODIMENTS

In the following description of preferred embodiments of the present invention, the same or similar reference numerals shall be used for the elements depicted in the various figures and acting in a similar way, wherein repeated description of these elements shall be omitted.

FIG. 1 shows a principle illustration of a technical device 100 provided with an input system 100 to according to an embodiment of the present invention. In the embodiment shown in FIG. 1, the technical device 100 is a computer, of which the screen is shown by way of representation. A user 104 is working on or with a program stored in the computer 100 by means of the input system 100 to in the illustration of FIG. 1. The input system 100 to comprises an input device 106 and a hand support 108. In the embodiment shown in FIG. 1, the input device 106 is a keyboard or computer keyboard. Alternatively, the input device 106 may also be a mouse, a joystick, etc., the technical device 100 is connected to the input device 106 and the input device 106 to the hand support 108 in electrically conductive manner for data transmission. Instead of connecting cables 110, a wireless connection may also be provided.

The hand support 108 serves to support the hands 112, in particular the heels of the hands or wrist joints, of the user 104 when working with the technical device 100 by means of the keyboard 106. Correspondingly, the hand support 108 may also be referred to as a thenar rest. In the embodiment shown in FIG. 1, hand support or thenar rest 108 has a rectangular shape with a length allowing the user 104 to comfortably place the wrist joints or heels of both hands 112 on the hand support 108 when working with the input device 106. The hand support 108 comprises a housing 114 of elastically deformable plastics and an apparatus (not shown in FIG. 1) at least partially embedded in the housing 114 for actuating the hand support 108. The shape and the elastic housing 114 of the hand support 108 enable guarding against fatigue or painful conditions of the hands 112 or wrist joints of the user 104 when working with the computer 100 for prolonged periods of time.

In the embodiment shown in FIG. 1, the input system 102 is formed in two pieces. The hand support 108 is positioned between the keyboard 106 and the user 104 on a surface carrying the computer 100 and the input system 102, e.g., a desk, adjacent to the keyboard 106 and is removably attached to the keyboard 106 by means of two snap-fits 116. Thus, the user 104 may remove the hand support 108 from the input device 106 at will by actuating the snap-fits 116 and continue working without the hand support 108 or attach the same to another suitable input device. Instead of the snap-fits 116, other elements for removably attaching can be used as an alternative. According to alternative embodiments, the input system 102 may also be formed integrally. In this case, there is a transition of the input device 106 to the hand support 108 without spatial separation, wherein the input device 106 and the hand support 108 may be formed from different materials, so that the input device 106 comprises a rigid housing, and the hand support 108 and elastic housing 114, as described above.

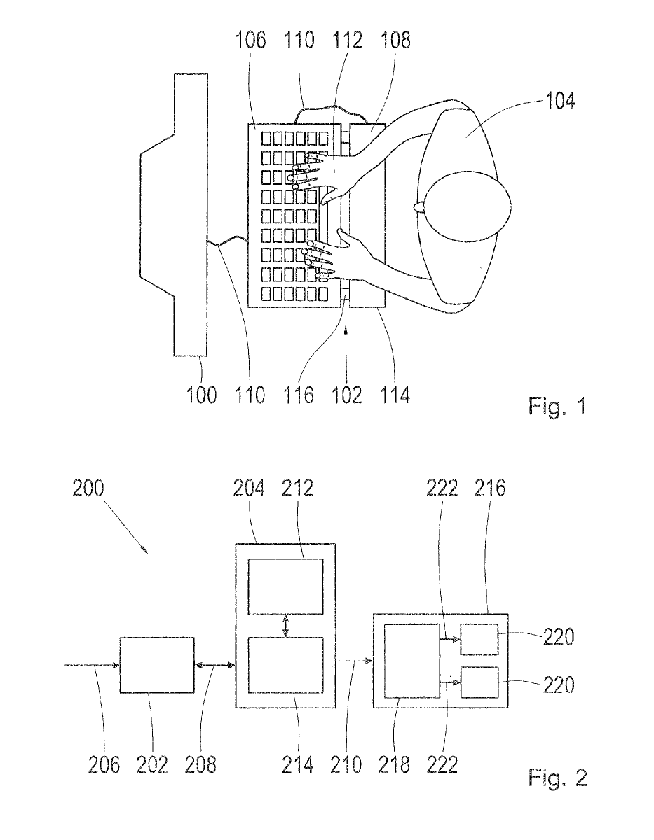

FIG. 2 shows a block diagram of an embodiment of an apparatus 200 for actuating the hand support integrated or integratable into the hand support of FIG. 1. The apparatus 200 may be referred to as an electronic section of the hand support and comprises an input interface 202 and a signal processing device 204 coupled to the input interface 202. The input interface 202 is configured to receive, via a data link to an input device for a technical device, an audio signal 206 from the input device. The input device may be the keyboard shown in FIG. 1, and the technical device may be the computer shown in FIG. 1. In the embodiment of the apparatus 200 as shown in FIG. 2, the input interface is designed as a USB interface. The signal processing device 204 coupled to the input interface 202 is configured to determine, using audio data 208 transmitted via the audio signal 206, an actuation signal 210 configured to effect actuation of the hand support in a manner characterising the audio signal 206.

In the embodiment of the apparatus 200 as shown in FIG. 2, the signal processing device 204 comprises a storage device 212 and an integrated circuit coupled to the storage device 212 in form of a microcontroller 214. According to this embodiment, reference audio data with which various actuation signals 210 are associated are filed in the storage device 212. In the embodiment of the apparatus 200 as shown in FIG. 2, the storage device 212 is an EEPROM. According to embodiments, the storage device 212 may also be another suitable non-volatile electronic storage medium. The microcontroller 214 is configured to compare the audio data 208 read into the apparatus 200 via the audio signal 206 to the reference audio data using a suitable algorithm and thus determine the actuation signal 210.

In the embodiment shown in FIG. 2, the apparatus 200 further comprises an actuating device 216 configured to receive the actuation signal 210 from the signal processing device 204 via a suitable interface. In the embodiment of the apparatus 200 as shown in FIG. 2, the actuating device 216 comprises a signal amplifier 218 and two actuators 220 coupled with the signal amplifier 218. The signal amplifier or high voltage amplifier 218 is configured to suitably amplify the actuation signal 210 provided via the signal processing device 204 and provide the same to each of the actuators 220 as an amplified actuation signal 222. The actuators 220 may be arranged adjacently with respect to each other or spaced from each other in the hand support and configured to cause actuation of the hand support in response to the amplified actuation signal 222 in a manner haptically perceptible for a user of the technical device when manipulating the input device linked to the hand support.

In the embodiment of the apparatus 200 as shown in FIG. 2, the actuators 220 are designed as small electric motors starting up when driven by means of the amplified actuation signal 222 and causing vibration of the hand support in a manner perceptible for the user of the technical device in their hands. In summary, by means of the devices 202, 204, 216 of the apparatus 200, the hand support is actuated in a manner characterising the read audio signal 206 and unmistakably haptically perceptible for the user of the attached technical device via their hands.

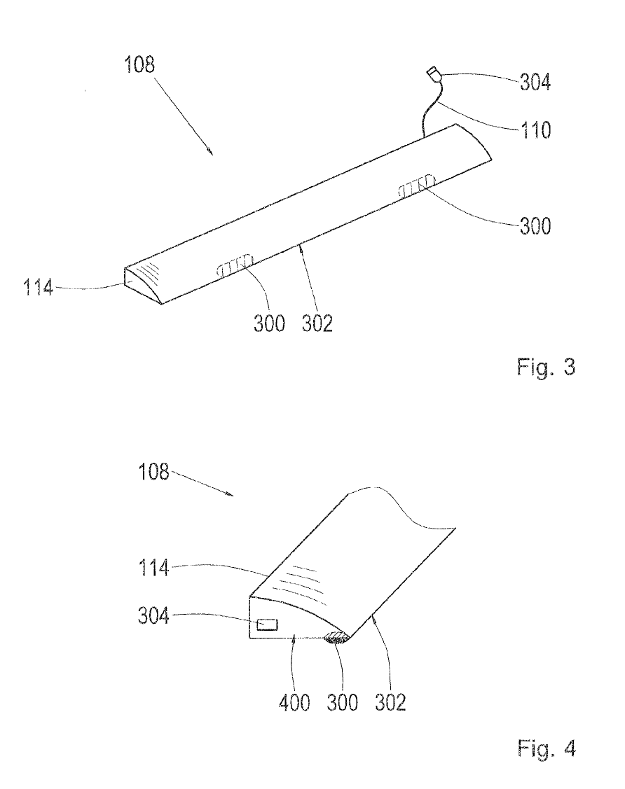

FIG. 3 shows a perspective view of an embodiment of a hand support 108 for an input device as presented herein. As already mentioned, the hand support 108 is designed as an elongated element. The embodiment of the hand support 108 as shown in FIG. 3 further has a wedge-shaped cross-section. The wedge shape has the advantage that the hand support 108 thus is designed so as to be particularly economic for the user. In this context, it is important to position the hand support 108 at the input device—not shown here—such that a point of the wedge faces the user and a base of the wedge opposite from the point is positioned so as to be adjacent to the input device. In keeping with its relaxation function for the heels of the hands or wrist joints of the user, the hand support 108 may also be referred to as a palm rest. In the illustration FIG. 3, the hand support 108 is depicted with a viewing direction towards the housing 114, into which the apparatus for actuating the hand support 108 as shown in FIG. 2 is embedded completely or partially.

As already mentioned, the housing 114 is formed of an elastic lead deformable material, here a plastics material. To be concrete, in the embodiment of the hand support as shown in FIG. 3, the housing 114 is formed of a foam material covered with a robust, yet flexible plastics layer, for example synthetic leather. If the housing is formed of elastic plastics, the hand support 108 is particularly suited for comfortably supporting the heels of the hands or wrist joints of a user, even when working with the technical device coupled to the palm rest 108 for a longer period of time.

Hatched areas of the embodiment of the hand support 108 as shown in FIG. 3 indicate to pads 300, which are not visible as such in FIG. 3, and which are arranged on a bottom side 302 of the housing 114 facing a surface for the hand support 108. As shown in the illustration, the pads 300 are arranged directly adjacent to the point of the wedge of the wedge-shaped hand support 108 on the bottom side 302. The pads 300 are arranged spaced from each other on the bottom side 302 of the housing 114 or set into the bottom side 302. Here, the pads 300 may each be arranged at an equal distance from opposite narrow sides of the housing 114.

The pads 300 are at positions of the housing 114 at which the hands or heels of the hands or wrist joints of a person working with the linked input device are very likely to rest on the hand support 108. This makes sense as the actuators presented in FIG. 2 each are arranged directly above each of the pads 300 in the housing 114, in the embodiment shown in FIG. 3. Within the housing 114, the actuators are arranged in a planar manner, i.e., substantially parallel to the bottom side 302 of the housing 114. The pads 300 is formed of elastically deformable and additionally rubber-like plastics. According to embodiments, the pads may be set into the bottom side 302 of the housing 114 in form of anti-slip rubber feet and may correspondingly be referred to as rubber pads.

The coupling of the pads 300 with the actuators as well as their strategic position causes the actuation of the hand support 108 by the actuators to take place selectively in a particularly pronounced manner at a probable location of the hands of a user. In this way, a haptically perceptible actuation caused by the actuators may transmitted to the hands of the user in a particularly effective way. In the embodiment shown in FIG. 3, the actuators are configured to cause vibration of the hand support or the pads 300 coupled to the actuators. Thus, the user receives, via their hands, force feedback of the information linked to the audio signal processed in the hand support. The use of a rubber material for the pads 300 also makes sure that the hand support 108 does not inadvertently slip on the surface when the hand support 108 is actuated or vibrated by means of the actuators. According to embodiments, only one pad 300 or more than two pads 300 may be provided.

As a further feature, the embodiment of the hand support 108 as shown in FIG. 3 comprises a connector 304 for coupling the hand support 108 to an input device in an electrically conductive manner. Here, the connector 304 is connected, via the connecting cable 110 guided out of the housing 114, to the input interface—not shown in FIG. 3 and designed as a USB interface—of the apparatus for actuating the hand support 108 integrated in the hand support 108. The connecting cable 110 has one end fixed to the housing 114, whereas the connector 304 is fixed to a free end 306—opposite to the one end—of the connecting cable 110. The connector 304 shown in FIG. 3 is a USB connector of conventional size. As shown in the illustration of FIG. 3, the palm rest 108 realized in accordance with the concept presented here may be employed in a versatile manner with vibration modules as a discrete application in combination with any input devices.

FIG. 4 shows a portion of another exemplary hand support 108 for an input device of a technical device by means of a further perspective view. As shown in the side you, the hand support 108 again is designed so as to be wedge-shaped. In contrast to FIG. 3, the pads 300—only one is shown—again are arranged on the bottom side 302 of the housing 114, but all the way out on the long side of the housing 114 forming the point of the wedge, adjacent to the narrow sides of the housing 114. As a further difference with respect to the embodiment shown in FIG. 3, the hand support 180 shown in FIG. 4 comprises the USB connector 304 integrated into a wall 400 of the housing 114. For example, the USB connector 304 may be integrated into one of the narrow sides of the housing 114. The connector 304 is designed so as to accommodate a further connector which can be plugged together with the connector 304 for electrically connecting the apparatus with the input device. In the embodiment shown in FIG. 4, the connector 304 is designed as a mini connector as part of a mini USB interface.

By means of the USB interface 304, which is shown in normal size in FIG. 3 and in mini implementation in FIG. 4, the audio signal data are passed on to the microcontroller or MCU explained on the basis of FIG. 2, so as to evaluate the same by means of software executed or executable on the microcontroller. After the evaluation, the MCU communicates the required data to the high voltage amplifier also shown in FIG. 2. It amplifies the signal is to 1 kV, for example, for the actuators. Thus, the palm rest 108 pulsates with corresponding signals. In the embodiment shown in FIG. 4, the hand support 108 also is designed as a separate vibrating palm rest for any input devices.

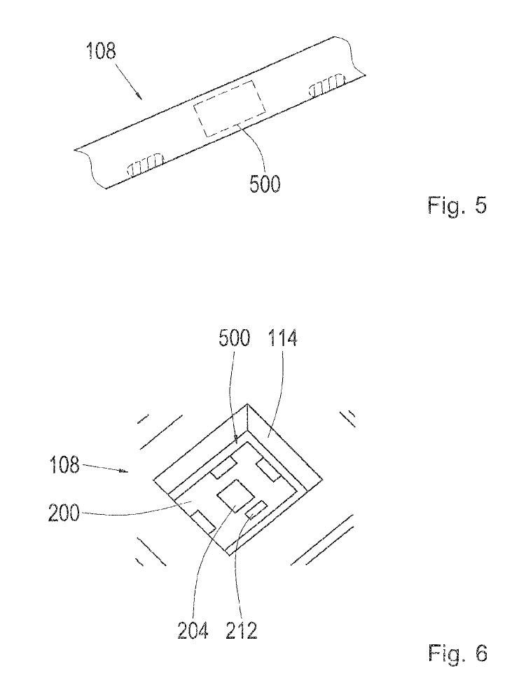

FIG. 5 shows, in a top view onto a portion of the exemplary hand support 108 from FIG. 3, by means of a dashed line, an exemplary mounting location 500 of at least a portion of the electronic section of the apparatus for actuating the hand support 108 presented in FIG. 2, wherein the electronic section comprises the EEPROM, the microcontroller, the mini USB interface, the high voltage amplifier and the actuators, according to embodiments.

FIG. 6 shows a perspective view of an exemplary integration of the apparatus 200 at the mounting location 500 of the hand support 108. As shown in the illustration, the mounting location 500 is designed as a rectangular recess in the housing 114 of the hand support 108. The apparatus 200—also having a rectangular shape here—or parts of the apparatus are arranged at the bottom of the recess 500. What is shown is the centrally arranged signal processing device 204, the storage device 212 adjacent thereto, and three contacts in a periphery of the apparatus, for example for connecting the actuators. The elements 204, 212 of the apparatus 200 may be arranged on a circuit board of the apparatus 200.

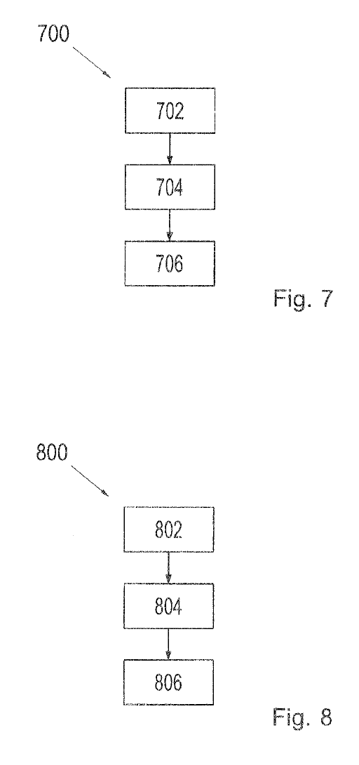

FIG. 7 shows a flowchart of an embodiment of a method 700 for actuating a hand support for an input device. Executing the method 700, for example, a hand support in form of a vibrating palm rest, as shown in FIGS. 3 and 4, may be actuated. In a step 702, an input interface, for example a USB interface of an apparatus for actuating the hand support integrated into the hand support, receives an audio signal of an input device for a technical device, wherein the input device is coupled to the hand support in an electrically conductive manner. In a step 704, an actuation signal is provided to actuators of the hand support using audio data transmitted via the audio signal by means of a signal processing device coupled to the USB input interface. In response to the actuation signal, in a step 706, the actuators cause vibration of the hand support in a manner characterising the audio signal.

FIG. 8 shows a flowchart of an embodiment of a production method 800 for producing a hand support for an input device. In a step 802, and apparatus for actuating a hand support is presented in the illustration of FIG. 2 is provided. In a step 804, a housing for the hand support is provided. In a step 806, the apparatus is integrated at least partially into the housing in order to complete the hand support as a separate actuatable palm rest for any input devices.

The embodiments described and depicted in the figures are chosen to be merely exemplary. Different embodiments may be combined with each other completely or with respect to distinct features. Also, one embodiment may be supplemented by features of another embodiment. Furthermore, the method steps presented here may be carried out repeatedly and in an order different from the one described.

In case an embodiment includes a first feature and a second feature linked by “and/or”, this means that the embodiment comprises, in one embodiment, both the first feature and the second feature and, in a further embodiment, comprises only one of the first feature and the second feature.

### REFERENCE NUMERALS

100 technical device

102 input system

104 user

106 input device

108 hand support

110 connecting cable

112 hand

114 housing

116 snap-fit

200 apparatus for actuating a hand support

202 input interface

204 signal processing device

206 audio signal

208 audio data

210 actuation signal

212 storage device

214 microcontroller

216 actuating device

218 signal amplifier

220 actuator

222 amplified actuation signal

300 pad

302 bottom side of the housing

304 connector

306 free end of the connecting cable

400 wall of the housing

500 mounting location of at least a portion of the apparatus

700 method for actuating a hand support

702 step of receiving the audio signal

704 step of providing the actuation signal

706 step of actuating the hand support

800 method for producing a hand support

802 step of providing an apparatus for actuating the hand support

804 step of providing a housing for the hand support

806 step of combining the apparatus with the housing

1. An apparatus for actuating a hand support for an input device, in particular a keyboard, of a technical device, the apparatus comprising:
an input interface for receiving an audio signal; and
a signal processing device which is coupled to the input interface and is configured to provide an actuation signal using audio data transmitted via the audio signal;
wherein the actuation signal is configured to actuate the hand support in a manner characterizing the audio signal.

2. The apparatus of claim 1, wherein the input interface comprises a connector, in particular of a USB interface.

3. The apparatus of claim 1, wherein the signal processing device comprises a storage device for storing reference audio data; and wherein the signal processing device is configured to provide the actuation signal using the reference audio data.

4. The apparatus of claim 1, wherein the apparatus further comprises an actuating device coupled to the signal processing device and configured to effect actuation in a manner haptically perceptible for a user of the technical device who manipulates the input device.

5. The apparatus of claim 4, wherein the haptically perceptible manner of the actuation is a vibration of at least a portion of the hand support.

6. The apparatus of claim 4, wherein the actuating device comprises a signal amplifier for amplifying the actuation signal and at least one actuator coupled to the signal amplifier; and wherein the actuator is configured to perform the actuation responsive to an actuation signal amplified by the signal amplifier.

7. A hand support for an input device, in particular a keyboard, of a technical device, the hand support comprising:
an apparatus comprising an input interface for receiving an audio signal and a signal processing device which is coupled to the input interface and is configured to provide an actuation signal using audio data transmitted via the audio signal;
wherein the actuation signal is configured to actuate the hand support in a manner characterizing the audio signal; and
a housing; wherein at least the signal processing device is arranged inside the housing.

8. The hand support of claim 7, wherein the housing is formed at least partially elastically deformable plastics.

9. The hand support of claim 7, wherein the housing comprises at least one elastically deformable pad on an outside; and wherein the pad is coupled to the at least one actuator.

10. The hand support of claim 7, wherein the connector is integrated into a wall of the housing; and wherein the connector is configured to accommodate a further connector pluggable together with the connector for electrically connecting the apparatus to the input device.

11. The hand support of claim 7, wherein the input interface comprises a connecting cable guided out of the housing; and wherein the connector is arranged at a free end of the connecting cable.

12. The hand support of claim 7, wherein the housing comprises at least one snap-fit for attaching the hand support to the input device.

13. An input system for a technical device, the input system comprising:
an input device, in particular a keyboard; and
a hand support comprising, an apparatus; wherein the apparatus comprises an input interface for receiving an audio signal and a signal processing device which is coupled to the input interface and is configured to provide an actuation signal using audio data transmitted via the audio signal; wherein the actuation signal is configured to actuate the hand support in a manner characterizing the audio signal; and
a housing; wherein at least the signal processing device is arranged inside the housing;
wherein the input device and the hand support are integrally formed or the hand support is removably attachable or attached to the input device via at least one snap-fit.

14. A method for actuating a hand support for an input device, in particular a keyboard, of a technical device, the method comprising:
receiving an audio signal via an input interface; and
providing an actuation signal via a signal processing device using audio data transmitted via the audio signal; wherein the signal processing device is coupled to the input interface to actuate the hand support in a manner characterizing the audio signal.

15. (canceled)

16. The apparatus of claim 2, wherein the signal processing device comprises a storage device for storing reference audio data; and wherein the signal processing device is configured to provide the actuation signal using the reference audio data.

17. The apparatus of claim 2, wherein the apparatus further comprises an actuating device coupled to the signal processing device and configured to effect actuation in a manner haptically perceptible for a user of the technical device who manipulates the input device.

18. The apparatus of claim 5, wherein the actuating device comprises a signal amplifier for amplifying the actuation signal and at least one actuator coupled to the signal amplifier; and wherein the actuator is configured to perform the actuation responsive to an actuation signal amplified by the signal amplifier.

19. The hand support of claim 8, wherein the housing comprises at least one elastically deformable pad on an outside; and wherein the pad is coupled to the at least one actuator.
